(19) United States
(12) Patent Application Publication
(10) Pub. No.: US 2026/0116125 A1
(43) Pub. Date: Apr. 30, 2026

(54) Ball Caster Mechanism

(71) Applicant: Jake Scott, Madison, TN (US)

(72) Inventor: Jake Scott, Madison, TN (US)

(21) Appl. No.: 19/349,963

(22) Filed: Oct. 4, 2025

Related U.S. Application Data
(60) Provisional application No. 63/712,940, filed on Oct. 28, 2024.

(51) Int. Cl. B60B 33/08; B60B 33/00

(52) U.S. Cl. CPC B60B 33/08; B60B 33/0018; B60B 33/0021

(57) ABSTRACT

A ball-caster assembly replaces a traditional swivel caster with a central spherical wheel [1] retained by multiple transfer bearings [4] carried on support arms [3] of a support structure [5]. The transfer bearings [4] roll against the spherical wheel [1] to reduce friction and distribute load, allowing the wheel to rotate about any axis and to passively align in the direction of travel. A stability ring [2] may join the support arms [3] to maintain geometry under load. The support structure [5] provides a mounting interface (e.g., stem or plate) for retrofit to a wheelchair or other caster-equipped device. The assembly enables zero-radius turns and smooth direction changes under load while reducing caster flutter and lateral jolts or whiplash. Although optimized for wheelchairs, the mechanism is adaptable to hospital beds, carts, trolleys, and robotic platforms.

### CROSS-REFERENCE TO RELATED APPLICATIONS

This application claims the benefit of U.S. Provisional Patent Application No. 63/712,940, filed Oct. 28, 2024, titled “Seamless Zero-Turn Uniball Mechanism for Enhanced Mobility in Wheelchairs and Caster-Based Devices,” the entirety of which is incorporated by reference as though quoted verbatim herein.

### FIELD OF THE INVENTION

This invention relates to multi-directional wheel assemblies for caster-equipped devices. In particular, it concerns a spherical ball-caster assembly for wheelchairs and similar mobility devices, configured to replace traditional swivel casters.

### BACKGROUND OF THE INVENTION

Conventional caster wheels swivel about a vertical axis to align with the direction of motion. During rapid reversals or zero-turn maneuvers, the caster fork can lag, flutter, or snap into alignment, causing lateral jolts, increased effort, and potential loss of control. The problem is pronounced under higher loads and in confined indoor spaces. Ball-type casters have been proposed to allow rolling in multiple directions, but known arrangements can concentrate load at limited contact points or still require partial realignment, leading to friction, uneven wear, and instability associated with whiplash. There remains a need for a compact, load-sharing spherical caster that passively aligns in all directions, minimizes friction at start and during transitions, and integrates with standard wheelchair mounting interfaces.

### SUMMARY OF THE INVENTION

A ball-caster wheel assembly is provided that replaces a traditional swivel caster. A central spherical wheel [1] is retained within a support structure [5] by a plurality of transfer bearings [4] carried on support arms [3], the support arms being joined for stiffness (e.g., by a stability ring [2]). The transfer bearings [4] roll against the spherical wheel [1] to reduce friction and distribute load, allowing the spherical wheel to rotate about any axis and to passively align without swivel lag. The support structure [5] includes a mounting interface (e.g., a stem or plate) for attachment to a wheelchair frame or other device. The assembly provides zero-radius turning and smooth directional changes under load while reducing lateral jolts or whiplash. Although optimized for wheelchairs, the assembly is applicable to many applications where casters are utilized.

### BRIEF DESCRIPTION OF THE DRAWINGS

FIG. 1 is a perspective view of an exemplary ball-caster assembly according to the invention, shown as a standalone unit. The central spherical wheel [1] and supporting structure including support arms [3], top transfer bearing housing with mounting shaft [5] and transfer bearings [4] are visible. Each support arm is connected for stabilization via the stability ring [2].

FIG. 2 is a side or front view of the wheel assembly, illustrating how the spherical wheel [1] is retained and supported by the transfer bearings [4] within the support structure [5,3]. Each support arm is connected for stabilization via the stability ring [2].

FIG. 3 is a collection of views incorporating close ups of the contact points of how the transfer bearings [4] are contacting the ball [1].

### LIST OF REFERENCE NUMERALS

[1] spherical wheel (uniball)
[2] stability ring (arm-to-arm stiffener)
[3] support arms
[4]transfer bearings
[5] top transfer-bearing housing with mounting shaft/mounting interface

### Detailed Description of the Preferred Embodiment

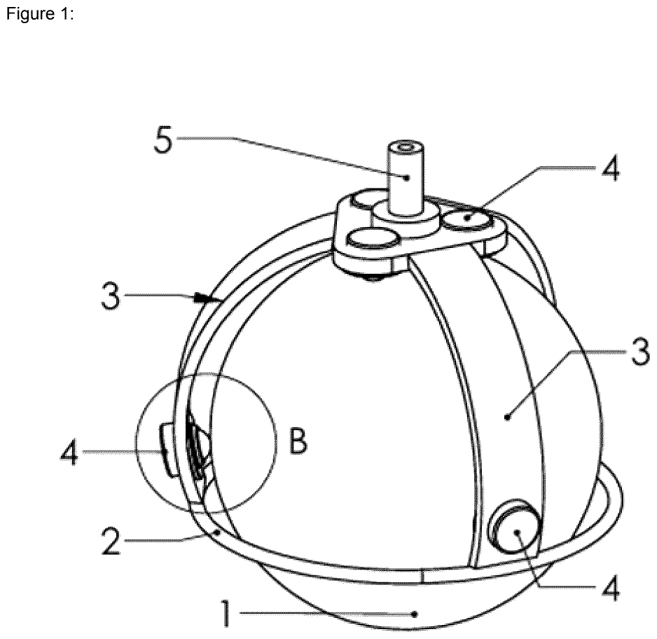

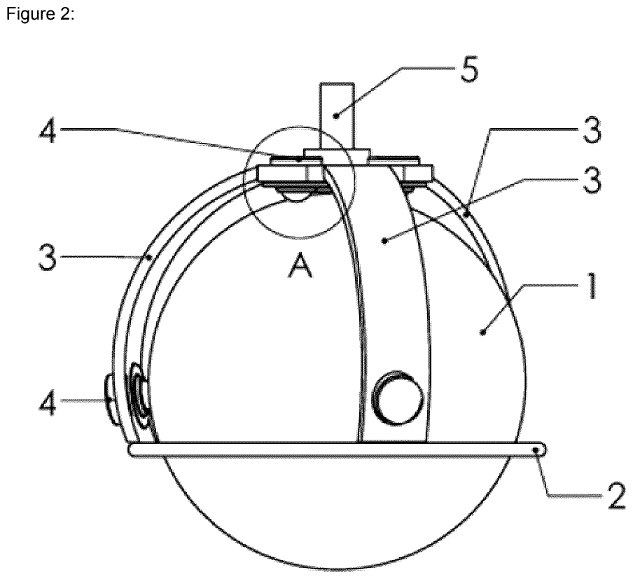

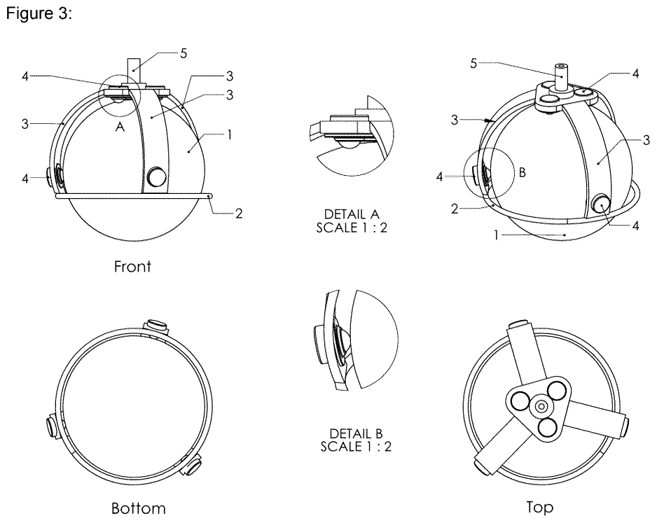

Referring to FIGS. 1-3, a preferred embodiment of the ball-caster wheel assembly includes a spherical wheel [1] retained within a support structure [5] by multiple support arms [3]. The spherical wheel [1] projects below the assembly to contact the ground and is free to rotate 360° about its center, providing omnidirectional motion without fork swivel or whiplash.

Support structure and retention. The support structure [5] serves as the main chassis and mounting interface. Plural support arms [3] extend downward to surround the spherical wheel [1]. Each support arm [3] carries at its inner end a transfer bearing [4] positioned to roll on the surface of the spherical wheel [1]. The arms [3] are joined, for example, by a stability ring [2] to resist deflection and maintain bearing geometry. At least three transfer bearings [4], spaced around the wheel [1](e.g., approximately 120° apart), support the load and keep the wheel centered. The arms [3] may extend to at or slightly below the equator of the spherical wheel [1] to prevent dislodgement while preserving clearance for free rotation. Optional retainers (e.g., a partial cap) may be used without obstructing rotation

Mounting interface. The support structure [5] may incorporate a vertical mounting shaft or stem sized for a standard wheelchair caster socket, or a plate with bolt holes for carts and beds. This permits retrofit of the ball-caster assembly in place of a conventional caster with minimal modification, maintaining original ride height and geometry.

Materials. The spherical wheel [1] can comprise a rigid core (metal or engineering polymer) with an optional non-marring, high-traction tread (e.g., polyurethane or rubber). The transfer bearings [4] may be ball-transfer units or roller elements formed of hardened steel or equivalents. The support arms [3], stability ring [2], and support structure [5] can be metal (e.g., 4 of aluminum or steel) or high-strength composite to preserve alignment under load. Corrosion-resistant materials are preferred for durability.

Operation. In use, forces applied to the device cause the spherical wheel [1] to roll in the commanded direction with minimal starting friction due to the rolling interfaces of transfer bearings [4]. Direction reversals and zero-radius turns occur without swivel lag reducing, lateral joltsF or whiplash and driver effort. The broad contact patch of the spherical wheel [1] improves stability over gaps and small obstacles compared to narrow wheels.

Applications. While primarily described for wheelchairs, the disclosed assembly can be scaled and mounted to hospital beds, stretchers, trolleys, shopping carts, industrial carts, or robotic platforms, etc. Size, number, and placement of transfer bearings [4] and materials may be adapted to load and environment.

Variations. Embodiments may include additional support arms [3], compliant or damped mounts, dust shields for transfer bearings [4], or tread textures on the spherical wheel [1]. Such variations remain within the scope defined by the claims.

1. A wheel assembly for a mobility device, comprising: a spherical wheel [1] configured to support a load and roll upon a surface in any direction with minimal or no jolting; a support structure [5] carrying a plurality of support arms [3] extending around the spherical wheel [1]; a plurality of transfer bearings [4] mounted to the support arms [3] and engaging the spherical wheel [1] to permit rotation of the spherical wheel [1] about any axis; and a mounting interface on the support structure [5] configured to attach the assembly to a frame of the mobility device; whereby the spherical wheel [1] provides passive omnidirectional alignment enabling zero-radius turns without caster misalignment associated with whiplash.

2. The wheel assembly of claim 1, wherein at least three transfer bearings [4] are spaced apart around the spherical wheel [1] to distribute load and retain the spherical wheel [1] within the support structure [5].

3. The wheel assembly of claim 1, wherein the support arms [3] are joined by a stability ring [2] to maintain geometry of the transfer bearings [4] under load.

4. The wheel assembly of claim 1, wherein the support arms [3] extend to at or below the equator of the spherical wheel [1] to prevent dislodgement while allowing free rotation.

5. The wheel assembly of claim 1, wherein the support structure [5] includes a vertical mounting stem sized to fit a standard wheelchair caster socket.

6. The wheel assembly of claim 1, wherein the spherical wheel [1] comprises a rigid core and an elastomeric outer tread.

7. The wheel assembly of claim 1, wherein the transfer bearings [4] comprise ball-transfer units or roller elements formed of hardened steel or equivalent wear-resistant materials.

8. The wheel assembly of claim 1, further comprising a partial retainer overlying an upper portion of the spherical wheel [1] to inhibit dislodgement while preserving omnidirectional rotation.

9. The wheel assembly of claim 1, wherein the support structure [5] comprises a plate with fastener apertures configured to attach the assembly to a gurney, bed, medical cart, trolley, or similar frame.

10. The wheel assembly of claim 1, further comprising a shield or cover configured to reduce ingress of debris to the transfer bearings [4].

11. The wheel assembly of claim 1, wherein the spherical wheel [1] includes a textured or patterned tread to increase traction on smooth flooring.
